(19) United States
(12) Patent Application Publication
(10) Pub. No.: US 2015/0308489 A1
(43) Pub. Date: Oct. 29, 2015

(54) TURNING MECHANISM FOR A PIECE OF JEWELRY

(71) Applicant: Brilliant Jewelers/MJJ INC., New York, NY (US)

(72) Inventor: NICKOLAY YAKUBOVICH, Kings Point, NY (US)

(73) Assignee: Brilliant Jewelers/MJJ INC., New York, NY (US)

(21) Appl. No.: 14/264,754

(22) Filed: Apr. 29, 2014

(51) Int. Cl. F16C 11/06; A44C 9/00; A44C 7/00; A44C 5/00; A44C 25/00

(52) U.S. Cl. CPC F16C 11/06; A44C 5/00; A44C 25/001; A44C 7/00; A44C 9/0084

(57) ABSTRACT

A turning mechanism for a piece of jewelry, showing one of two opposing faces, includes a bale having a central opening and two opposite ends. At least one barbell-shaped pin has spheres at each end. The pin passes through at least one of the two opposite ends of the bale. One sphere projects into the central opening and secures the pin to the bale while the other sphere secures the piece of jewelry to the bale so that the piece of jewelry may be swiveled by a wearer to show another one of the two opposing faces. The faces may be “day” and “night”. The piece of jewelry may be a pendant on a necklace, an earring, a bracelet, or a ring. There may be a thickened portion of a trapezoidal shape at one of the two opposite ends of the bale to resist stresses and to prevent breakage of the pin.

### FIELD OF THE INVENTION

The present invention relates generally to jewelry, and more specifically, to a turning mechanism for a double-sided piece of jewelry having a pin structure with a bale portion for swiveling.

### BACKGROUND OF THE INVENTION

Conventional jewelry, whether in the nature of a pendant, an earring, a bracelet or a ring, has an ornamented front side and an unornamented back side.

Specifically, in such conventional jewelry, only the front side is intended to be viewed by an onlooker while the back side provides only a support function. If the wearer wishes to show a different view, she must change the piece of jewelry by taking off one and putting on another. This constant changing can be tiresome, particularly if the wearer has a long day, for example, spending the day time in a work environment, then spending the evening in an entertainment environment. Wearers prefer to project a look which is different in the evening than in the day.

It has long been a goal of the jewelry industry to provide wearers with pendants, earrings, bracelets and rings which project one business-like image during the day and another alluring image during the night time.

It is further desirable to have a single piece of jewelry which is quickly and easily convertible from one look to another without the necessity and risk of carrying multiple pieces of valuable jewelry that may become entangled in one's purse.

Thus, double-sided pieces of jewelry that are simple, inexpensive and easy to use, yet still being attractive, have been developed since about 1980. All of these double-sided pieces have various turning mechanisms, some of which are more complicated and prone to breakage than others, for alternately showing different sides of the same piece of jewelry.

One type of conventional turning mechanism is described in U.S. Pat. No. 4,265,098 which was issued to Kurt Wayne on May 5, 1981. The Wayne patent discloses a device for carrying a pendant which is removable from a chain or necklace that has an aperture into which is inserted a top bar of a T-shaped member that carries the pendant. A movable element, having a protuberance extending through the aperture, is provided for closure of the aperture and for locking the pendant within the device. See FIGS. 1 and 2, in particular.

An example of a pendant positioner is provided in U.S. Patent Application Publication No. 2003/0019242 which was published on Jan. 30, 2003, in the name of James White. The White publication discloses a device applicable to the positioning of a loose object on a carrier such as a device mounted on a necklace with a pendant to keep the pendant in a stationary position on the necklace. The necklace is contained in an opening in a coil with a locating section serving to retain the pendant in position on the necklace. Optional end configurations serve to reduce the risks of necklace entanglement and friction between the device and the necklace. See FIG. 10, in particular.

Another example of a prior art pendant is provided in U.S. Patent Application Publication No. 2012/0279461 which was published on Nov. 8, 2012, in the name of Cathy Patricia Levell. The Levell publication discloses a leash pendant which includes a pendant-shaped hollow housing containing a rotatably mounted reel. A free end of the leash is provided with a clip or other releasable fastener. See FIGS. 1-3, in particular.

Yet another example of prior art jewelry is described in U.S. Patent Application Publication No. 2008/0016911 which was published on Jan. 24, 2008, in the name of David Ross Morgan. The Morgan publication discloses a reversible earring having a post and an ornament that is attached to the post by a spherical connection. The ornament has more than one face, and the spherical connection includes a ball and a cradle that partially encloses the ball, thus permitting the ornament to be reversed by swiveling the ornament about the spherical connection on axes of rotation that pass through the ball. In FIG. 1, a dark ornamental face is shown for wearing at night while in FIG. 2, a light ornamental face is shown for wearing during the day.

Other examples of reversible prior art jewelry are shown in the following: U.S. Pat. No. 6,032,486 issued to Uchin on Mar. 7, 2000; U.S. Pat. No. 6,550,276 issued to Frank on Apr. 22, 2003; U.S. Pat. No. 7,316,129 issued to Meguro on Jan. 8, 2008; and U.S. Pat. No. 7,322,213 issued to Tamir et al. on Jan. 29, 2008.

### SUMMARY OF THE INVENTION

According to the present invention, a turning mechanism is provided for a piece of jewelry that is simple, inexpensive to make, and easy to use, yet still is attractive.

In one aspect of the invention, the turning mechanism is configured for a double-sided piece of jewelry having a pin structure with a bale portion for swiveling.

In one embodiment of the invention, the turning mechanism is configured to work with a pendant on a necklace.

According to another embodiment of the invention, the turning mechanism can be shaped, sized and configured to work with an earring.

In yet another embodiment of the invention, the turning mechanism can be configured to work with a bracelet.

In another embodiment of the invention, the turning mechanism can be shaped, sized and configured to function with a ring.

In still another embodiment of the invention, the turning mechanism can be made of any material, including, but not limited to, a metal, a polymer, a ceramic, or any combination thereof. The metal can be any appropriate metal, e.g., stainless steel, sterling silver or gold.

### BRIEF DESCRIPTION OF THE DRAWINGS

The present invention is further described in the detailed description which follows, with reference to the drawings by way of examples of embodiments of the present invention, in which like reference numerals represent similar parts throughout the several views of the drawings.

FIG. 1 is a front view of a first embodiment of the invention.

FIG. 2 is an alternate front view of the first embodiment of the invention.

FIG. 3 is a front perspective view of a second embodiment of the invention.

FIG. 4 is an alternate perspective view of the second embodiment of the invention.

FIG. 5 is a top view of a third embodiment of the invention.

FIG. 6 is an alternate top view of the third embodiment of the invention.

FIG. 7 is a top view of a fourth embodiment of the invention.

FIG. 8 is an alternate top view of the fourth embodiment of the invention.

FIG. 9 is a side view of the fourth embodiment of the invention.

### DETAILED DESCRIPTION OF THE PREFERRED EMBODIMENTS

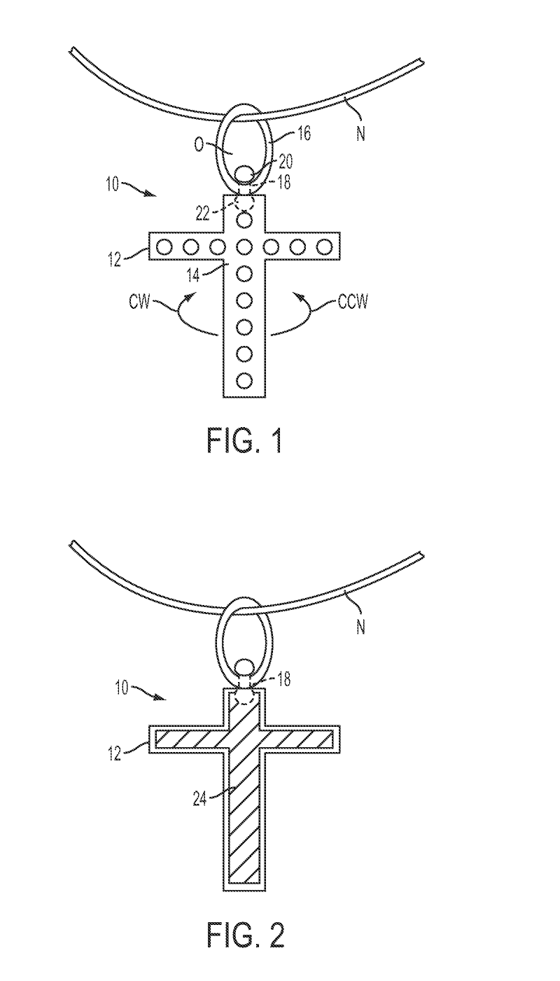

FIGS. 1 and 2 show views, according to a first embodiment of the present invention, with a turning mechanism 10 attached to a piece of jewelry, in this example, a pendant 12, which may be swiveled by the wearer, either clockwise or counterclockwise, on a necklace N.

FIG. 1 shows an arrow CW and another arrow CCW, indicating that the pendant 12 with its so-called “day” face 14, which is one of two opposing faces, may be turned in either direction on the necklace N in order to change the face viewed by an onlooker.

The turning mechanism 10 has a bale 16, which in this first embodiment has an oval shape and a central opening O, through which the necklace N is threaded at an upper end thereof. At an opposite lower end of the bale 16, there is a barbell-shaped pin 18 having spheres 20 and 22 at its opposite ends. The sphere 20 projects into the opening O and secures the pin 18 in a bore through the bale 16 while the sphere 22 secures the pendant 12 to the pin 18 which passes partially through a hole in a top surface of the pendant 12 which is suspended from the necklace N.

FIG. 2 shows the turning mechanism 10 with the pendant 12 swiveled around the pin 18 so that another one of the two opposing faces, in this case, a so-called “night” face 24 of the pendant 12 on the necklace N, is now turned towards the onlooker.

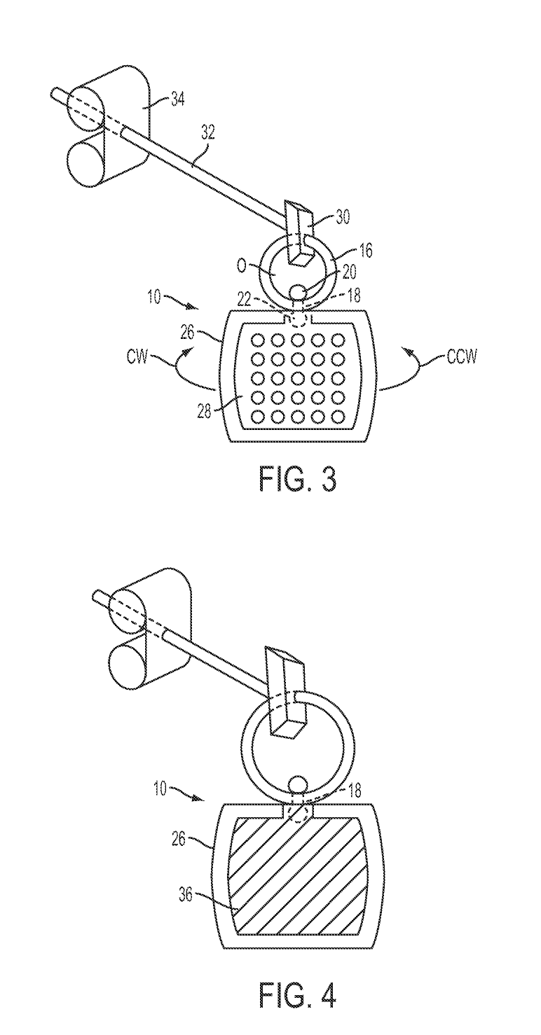

FIGS. 3 and 4 show views, according to a second embodiment of the present invention, with the turning mechanism 10 attached to another piece of jewelry, in this example, an earring 26, which may be swiveled by the wearer, either clockwise or counterclockwise.

FIG. 3 shows the arrows CW and CCW, indicating that the earring 26 with its so-called “day” face 28, which is one of two opposing faces, may be turned in either direction in order to change the face viewed by the onlooker.

The turning mechanism 10 has its bale 16, which in this second embodiment has a circular shape, pass through a bore in a toggle 30 at the upper end of the bale 16. The toggle 30 is secured at one end of a post 32 which pierces an ear lobe (not shown) of the wearer. The post 32 is held in place by a backing 34 mounted behind the ear lobe. At the opposite lower end of the bale 16, the barbell-shaped pin 18 has spheres 20 and 22 at its opposite ends. The sphere 20 projects into the opening O and secures the pin 18 in a bore through the bale 16 while the sphere 22 secures the earring 26 to the pin 18 which passes partially through a hole in a top surface of the earring 26.

FIG. 4 shows the turning mechanism 10 with the earring 26 swiveled around the pin 18 so that another one of the two opposing faces, in this case, a so-called “night” face 36 of the earring 26 is now turned towards the onlooker.

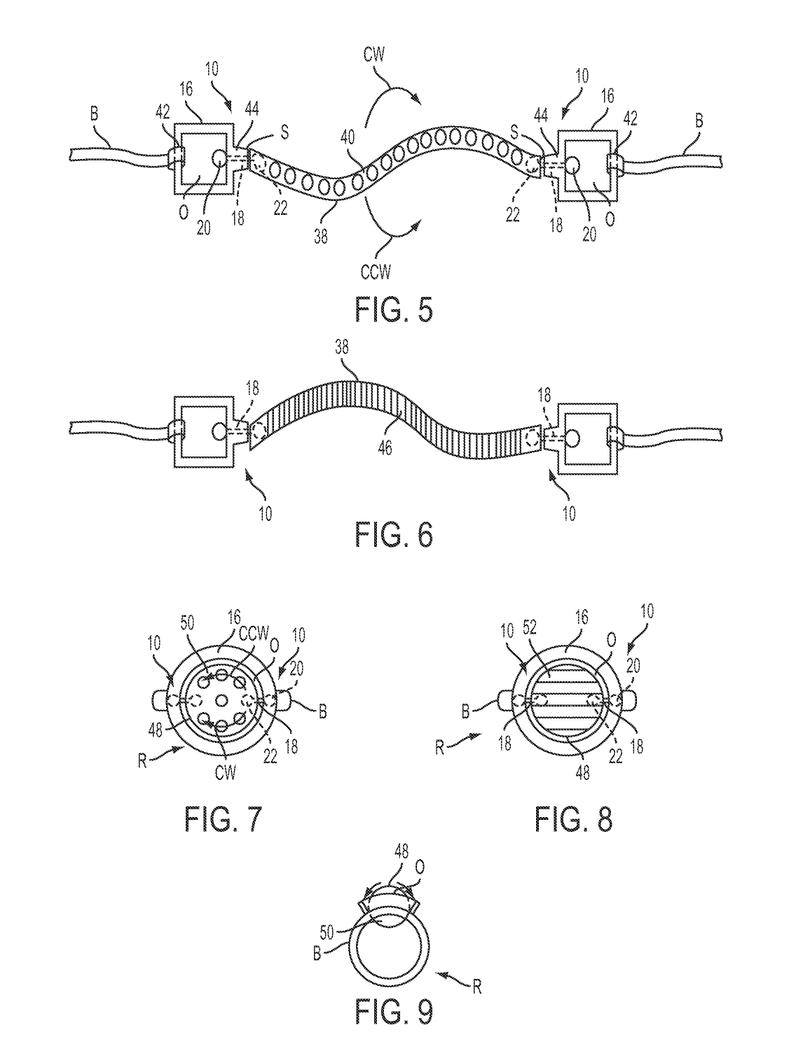

FIGS. 5 and 6 show views, according to a third embodiment of the present invention, with a pair of the turning mechanisms 10 attached to opposite ends of another piece of jewelry, in this example, a bracelet 38, which may be swiveled by the wearer, either clockwise or counterclockwise.

FIG. 5 shows the arrows CW and CCW, indicating that the bracelet 38 with its so-called “day” face 40, which is one of two opposing faces, may be turned in either direction in order to change the face viewed by the onlooker.

Each turning mechanism 10 has its bale 16, which in this third embodiment has a rectangular shape. At opposite sides of FIG. 5, an external side of the bale 16 passes through a clamp 42 at a terminal end of a band B. The band B wraps around a wrist (not shown) of the wearer. At an opposite internal side of the bale 16, the barbell-shaped pin 18 has spheres 20 and 22 at its opposite ends. The sphere 20 projects into the opening O and secures the pin 18 in a bore through the internal side of the bale 16 while the sphere 22 secures the bracelet 38 to the pin 18 which passes partially through a hole in a side surface S of the bracelet 38.

Because of stresses which the bracelet 38 endures due to its being pulled at two opposing side surfaces S by the band B, each of the opposite ends of each bale 16 has a thickened portion 44, in this example, having a trapezoidal shape, configured to resist such stresses and to prevent breakage of the pin 18 where it passes into the bracelet 38.

FIG. 6 shows each turning mechanism 10 with the bracelet 38 swiveled around the pins 18 so that another one of the two opposing faces, in this case, a so-called “night” face 46 of the bracelet 38 is now turned outwardly.

FIGS. 7-9 show views, according to a fourth embodiment of the present invention, with a pair of the turning mechanisms 10 attached to opposite ends of another piece of jewelry, in this example, a ring R, having a gem stone 48 which may be swiveled by the wearer, either clockwise or counterclockwise.

FIG. 7 shows the arrows CW and CCW, indicating that the gem stone 48 with its so-called “day” face 50, which is one of two opposing faces, may be turned in the opening O in either direction in order to change the face viewed by the onlooker.

Each turning mechanism 10 has its bale 16, which in this fourth embodiment has a circular shape, mounted at opposite ends of the band B of the ring R. The band B of the ring R wraps around a finger (not shown) of the wearer. At one end of the bale 16, the barbell-shaped pin 18 has spheres 20 and 22 at its opposite ends. The sphere 20 is secured inside the bale 16 while the sphere 22 secures the gem stone 48 in the opening O to the pin 18 which passes partially through a hole in a side surface of the gem stone 48.

FIG. 8 shows each turning mechanism 10 with the gem stone 48 swiveled around the pins 18 so that another one of the two opposing faces, in this case, a so-called “night” face 52 of the gem stone 48 is now turned in the opening O towards the onlooker.

FIG. 9 shows the gem stone 48 being swiveled half way through the process of being turned in the opening O from showing its “day” face 50 to showing its “night” face 52 (not shown). Of course, in order to carry out this turning process, the wearer must remove the band B of the ring R from her finger. After the “day” face 50 has been flipped into a downwardly facing position, the wearer may place the ring R back on her finger with the “night” face 52 (not shown) in an upwardly facing position.

The components of each piece of jewelry can be made of any suitable material, including, but not limited to, any metal, polymer, ceramic, or any combination thereof. The metal can be any appropriate metal, e.g., stainless steel, sterling silver or gold.

Accordingly, a turning mechanism is disclosed which has a simple mechanical structure, is reliable and durable. Thus, a heightened level of excitement for double-sided jewelry with dramatic “day” and “night” faces has been reached with the present invention. Such a level has not been shown or disclosed in any known prior art.

Furthermore, the “day” and “night” faces may have different surface textures, ornamental designs, repeating patterns, and shapes. Although the pendant 12 has a cross shape in FIGS. 1 and 2, the earring 26 has a rectangular shape in FIGS. 3 and 4, the bracelet 38 has an S shape in FIGS. 5 and 6, and the ring R holds the gem stone 48 having a circular shape in FIGS. 7-9, other shapes may be used. For example, the shape may be in the form of a FIG. 8 to signify infinity, two interlocking circles to signify a union, a diamond, a tear drop, a hoop, a heart, a square, a hexagon, an octagon, a rod, a four-leafed clover, an oval, an arrow, or a star.

It is noted that the foregoing examples have been provided merely for the purpose of explanation and are in no way to be construed as limiting the present invention. While the present invention has been described with reference to exemplary embodiments, it is understood that the words which have been used herein are words of description and illustration, rather than words of limitation. Changes may be made, within the purview of the appended claims, as presently stated, without departing from the scope and spirit of the present invention in all of its aspects. Although the present invention has been described herein with reference to particular elements, materials and embodiments, the present invention is not intended to be limited to the particulars disclosed herein. Rather, the present invention extends to all functionally equivalent structures, such as are within the scope of the appended claims.

What is claimed is:

1. A turning mechanism for a piece of jewelry showing one of two opposing faces, comprising:
a bale having a central opening and two opposite ends; and
at least one barbell-shaped pin having spheres at each end, said at least one pin passing through at least one of the two opposite ends of the bale;
wherein one sphere projects into the central opening and secures the pin to the bale while the other sphere secures the piece of jewelry to the bale so that the piece of jewelry may be swiveled by a wearer to show another one of the two opposing faces.

2. The mechanism according to claim 1, wherein the bale has an oval shape.

3. The mechanism according to claim 1, wherein the bale has a circular shape.

4. The mechanism according to claim 1, wherein the bale has a rectangular shape.

5. The mechanism according to claim 1, wherein the piece of jewelry is a pendant on a necklace.

6. The mechanism according to claim 1, wherein the piece of jewelry is an earring.

7. The mechanism according to claim 1, wherein the piece of jewelry is a bracelet.

8. The mechanism according to claim 1, wherein the piece of jewelry is a ring.

9. The mechanism according to claim 1, wherein one of the two opposing faces is a day face.

10. The mechanism according to claim 1, wherein another one of the two opposing faces is a night face.

11. The mechanism according claim 1, wherein there is a thickened portion at one of the two opposite ends of the bale.

12. The mechanism according to claim 11, wherein the thickened portion has a trapezoidal shape.

13. The mechanism according to claim 1, wherein the mechanism is made of at least one material including a metal, a polymer, a ceramic, or any combination thereof.

14. The item according to claim 13, wherein the at least one material is a metal.

15. The item according to claim 14, wherein the metal is one of stainless steel, sterling silver and gold.

16. A turning mechanism for a piece of jewelry showing one of two opposing faces, comprising:
a bale having a central opening and two opposite ends;
a first barbell-shaped pin having spheres at each end, said first pin passing through one of the two opposite ends of the bale; and
a second barbell-shaped pin also having spheres at each end, said second pin passing through the other one of the two opposite ends of the bale;
wherein one sphere of each pin secures each pin to the bale and the other sphere of each pin secures the piece of jewelry to the bale so that the piece of jewelry may be swiveled by a wearer in the central opening of the bale to show another one of the two opposing faces of the piece of jewelry.

17. The mechanism according to claim 16, wherein the bale has a circular shape.

18. The mechanism according to claim 16, wherein the piece of jewelry is a ring.

19. The mechanism according to claim 16, wherein one of the two opposing faces is a day face.

20. The mechanism according to claim 16, wherein another one of the two opposing faces is a night face.

21. A turning mechanism for a piece of jewelry showing one of two opposing faces, comprising:
a bale having a central opening and two opposite ends; and
at least one barbell-shaped pin having spheres at each end, said at least one pin passing through at least one of the two opposite ends of the bale;
wherein one sphere projects into the central opening and secures the pin to the bale while the other sphere secures the piece of jewelry to the bale so that the piece of jewelry may be swiveled by a wearer to show another one of the two opposing faces;
wherein the bale has a shape which is selected from a group including an oval, a circle, and a rectangle;
wherein the piece of jewelry is selected from a group including a pendant on a necklace, an earring, a bracelet, and a ring;
wherein one of the two opposing faces is a day face;
wherein another one of the two opposing faces is a night face; and
wherein the mechanism is made of at least one material including a metal, a polymer, a ceramic, or any combination thereof.
